(19) United States
(12) Patent Application Publication
(10) Pub. No.: US 2013/0219417 A1
(43) Pub. Date: Aug. 22, 2013

(54) Automated Personalization

(71) Applicants: Ross Gilson, Philadelphia, PA (US); Joseph Kokinda, Downingtown, PA (US); Christopher Stone, Newton, PA (US); Charles Herrin, Wayne, PA (US); Michael Connelly, Philadelphia, PA (US); Danial E. Holden, Englewood, CO (US)

(72) Inventors: Ross Gilson, Philadelphia, PA (US); Joseph Kokinda, Downingtown, PA (US); Christopher Stone, Newton, PA (US); Charles Herrin, Wayne, PA (US); Michael Connelly, Philadelphia, PA (US); Danial E. Holden, Englewood, CO (US)

(73) Assignee: Comcast Cable Communications, LLC, Philadelphia, PA (US)

(21) Appl. No.: 13/398,441

(22) Filed: Feb. 16, 2012

(51) Int. Cl. H04N 21/258

(52) U.S. Cl. 725/12

(57) ABSTRACT

System and methods for providing a user experience are described, including a method comprising identifying a user, determining a profile of the user, determining a parameter of a user experience, and automatically modifying the parameter of the user experience based upon the profile of the user.

### BACKGROUND

Users can often have different preferences and permissions when it comes to consuming content. For example, one user may like to watch action movies on the weekends with low lighting and high audio output levels. Conversely, another user may like to listen to classical music while viewing a digital photo album via a television. Further, parents can manually set permissions for certain content channels in order to limit content that their children can access. However, the current content control tools do not provide a sufficient means to automatically personalize a user experience and user preference.

### SUMMARY

It is to be understood that both the following summary and the following detailed description are exemplary and explanatory only and are not restrictive, as claimed. In an aspect, provided are methods and systems for automatically personalizing a user experience based upon one or more users. The systems and methods provided can enable, for example, a device or system to recognize the presence of a specific user and then adjust various parameters that define a user experience based upon one or more of the specific user's preferences, user state, behavior, permissions, and the like.

In an aspect, a method for providing a user experience can comprise identifying a user, determining a profile of the user, determining a parameter of a user experience, and automatically modifying the parameter of the user experience based upon the profile of the user.

In an aspect, a method for providing a user experience can comprise identifying a user, determining a profile of the user, automatically modifying a parameter of the user experience based upon the profile of the user, monitoring a state of the user, and modifying one or more of the profile of the user and the user experience to reflect the state of the user.

In an aspect, a method for providing a user experience can comprise identifying a user, determining a state of the user, and automatically modifying a parameter of the user experience based upon the state of the user.

In an aspect, a method for personalization of content can comprise identifying a user, determining a profile of the user, processing a plurality of available content to determine a preferred content based upon the profile of the user, and rendering the preferred content.

In an aspect, a system can comprise a sensor for capturing data relating to a user and a processor in communication with the sensor. The processor can be configured to determine a profile of the user based upon the data captured by the sensor, determine a parameter of a user experience, and automatically modify the parameter of the user experience based upon the profile of the user.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary network;

FIG. 2 is a block diagram of an exemplary system;

FIG. 3 is a block diagram of an exemplary system;

FIG. 4 is a flow chart of an exemplary method;

FIG. 5 is a block diagram of an exemplary system;

FIG. 6 is a flow chart of an exemplary method; and

FIG. 7 is a block diagram of an exemplary computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and comprise the disclosed systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As described in greater detail below, a system for rendering a user experience can be configured to automatically personalize the user experience based upon one or more users.

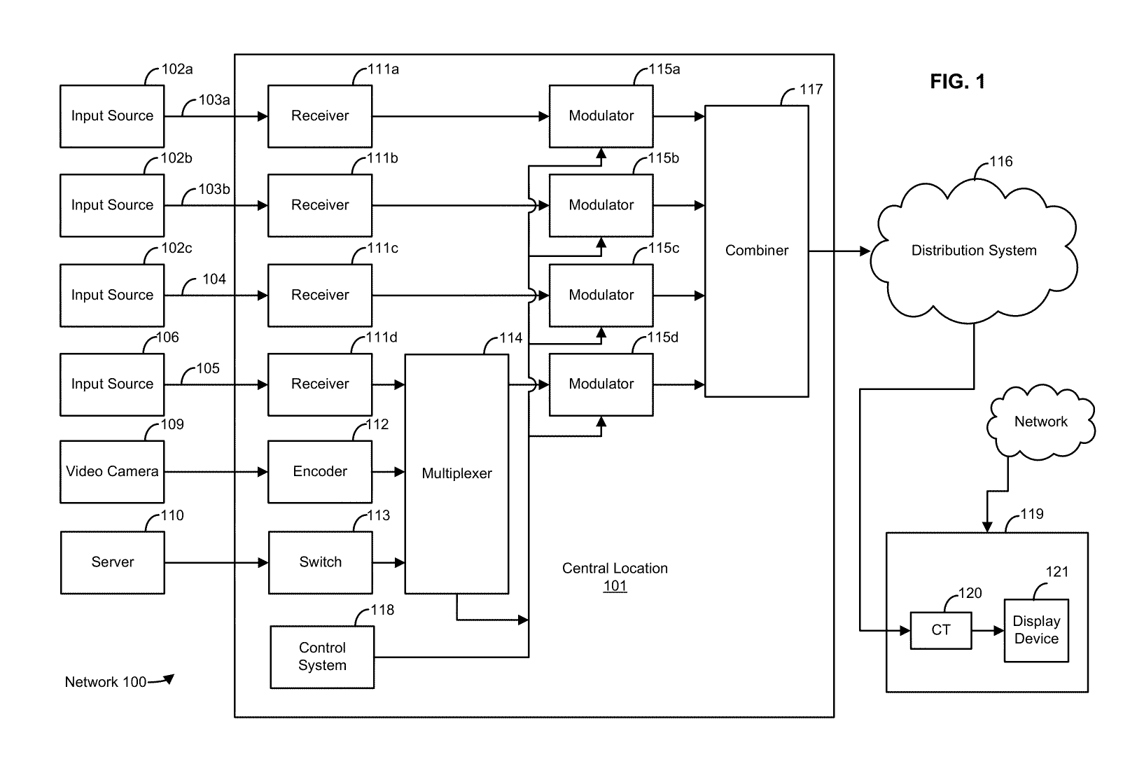

FIG. 1 illustrates various aspects of an exemplary network environment in which the present methods and systems can operate. The present disclosure relates to methods and systems for automatically personalizing a user experience. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The network 100 can comprise a central location 101 (e.g., a control or processing facility in a fiber optic network, wireless network or satellite network, a hybrid-fiber coaxial (HFC) content distribution center, a processing center, headend, etc.), which can receive content (e.g., data, input programming, and the like) from multiple sources. The central location 101 can combine content from the various sources and can distribute the content to user (e.g., subscriber) locations (e.g., location 119) via distribution system 116.

In an aspect, the central location 101 can create content or receive content from a variety of sources 102a, 102b, 102c. The content can be transmitted from the source to the central location 101 via a variety of transmission paths, including wireless (e.g. satellite paths 103a, 103b) and terrestrial (e.g., fiber optic, coaxial path 104). The central location 101 can also receive content from a direct feed source 106 via a direct line 105. Content may also be created at the central location 101. Other input sources can comprise capture devices such as a video camera 109 or a server 110. The signals provided by the content sources can include, for example, a single content item or a multiplex that includes several content items.

The central location 101 can comprise one or a plurality of receivers 111a, 111b, 111c, 111d that are each associated with an input source. In an aspect, the central location 101 can create and/or receive applications, such as interactive application, for example. For example, MPEG encoders such as encoder 112, are included for encoding local content or a video camera 109 feed. A switch 113 can provide access to server 110, which can be, for example, a pay-per-view server, a data server, an internet router, a network system, a phone system, and the like. Some signals may require additional processing, such as signal multiplexing, prior to being modulated. Such multiplexing can be performed by multiplexer (mux) 114.

The central location 101 can comprise one or a plurality of modulators, 115a, 115b, 115c, and 115d, for interfacing to the distribution system 116. The modulators can convert the received content into a modulated output signal suitable for transmission over the distribution system 116. The output signals from the modulators can be combined, using equipment such as a combiner 117, for input into the distribution system 116.

A control system 118 can permit a system operator to control and monitor the functions and performance of network 100. The control system 118 can interface, monitor, and/or control a variety of functions, including, but not limited to, the channel lineup for the television system, billing for each user, conditional access for content distributed to users, and the like. Control system 118 can provide input to the modulators for setting operating parameters, such as system specific MPEG table packet organization or conditional access information. The control system 118 can be located at central location 101 or at a remote location.

The distribution system 116 can distribute signals from the central location 101 to user locations, such as user location 119. In an aspect, the distribution system 116 can be in communication with an advertisement system for integrating and/or delivering advertisements to user locations. The distribution system 116 can be an optical fiber network, a coaxial cable network, a hybrid fiber-coaxial network, a wireless network, a satellite system, a direct broadcast system, or any combination thereof. There can be a multitude of user locations connected to distribution system 116. At user location 119, there may be an interface device 120 that may comprise a decoder, a gateway, a communications terminal (CT), or a mobile user device that can decode, if needed, the signals for display on a display device 121, such as a television, mobile device, a computer monitor, or the like. Those skilled in the art will appreciate that the signal can be decoded in a variety of equipment, including an CT, a computer, a TV, a monitor, or satellite dish. In an exemplary aspect, the methods and systems disclosed can be located within, or performed on, one or more CT's 120, display devices 121, central locations 101, DVR's, home theater PC's, and the like.

In an aspect, user location 119 is not fixed. By way of example, a user can receive content from the distribution system 116 on a mobile device such as a laptop computer, PDA, smart phone, GPS, vehicle entertainment system, portable media player, and the like.

In an aspect, a user device 124 can receive signals from the distribution system 116 for rendering content on the user device 124. As an example, rendering content can comprise providing audio and/or video, displaying images, facilitating an audio or visual feedback, tactile feedback, and the like. However, other content can be rendered via the user device 124. In an aspect, the user device 124 can be an CT, a set-top box, a television, a computer, a smart phone, a laptop, a tablet, a multimedia playback device, a portable electronic device, and the like. As an example, the user device 124 can be an Internet protocol compatible device for receiving signals via a network such as the Internet or some other communications network for providing content to the user. As a further example, other display devices and networks can be used. In an aspect, the user device 124 can be a widget or a virtual device for displaying content in a picture-in-picture environment such as on the display device 121, for example.

In an aspect, the methods and systems can utilize digital audio/video compression such as MPEG, or any other type of compression. The methods and systems can utilize digital content transport such as MPEG transport streams, real-time transport protocol (RTP), or any other type of transport. The Moving Pictures Experts Group (MPEG) was established by the International Standards Organization (ISO) for the purpose of creating standards for digital audio/video compression and content transport. The MPEG experts created the MPEG-1 and MPEG-2 standards, with the MPEG-1 standard being a subset of the MPEG-2 standard. The combined MPEG-1, MPEG-2, MPEG-4, MPEG-5 standards are hereinafter referred to as MPEG. In an MPEG encoded transmission, content and other data are transmitted in packets, which collectively make up a transport stream. Additional information regarding transport stream packets, the composition of the transport stream, types of MPEG tables, and other aspects of the MPEG standards are described below. In an exemplary embodiment, the present methods and systems can employ transmission of MPEG packets. However, the present methods and systems are not so limited, and can be implemented using other types of transmission and data.

As described in greater detail below, a system for rendering a user experience can be configured to automatically detect one or more users and personalize the user experience based upon the one or more users detected. In an aspect, the user experience can comprise a visual and/or audible content for user consumption. As an example, the user experience can comprise environmental characteristics such as lighting, temperature, tactile feedback, and/or other sensory feedbacks.

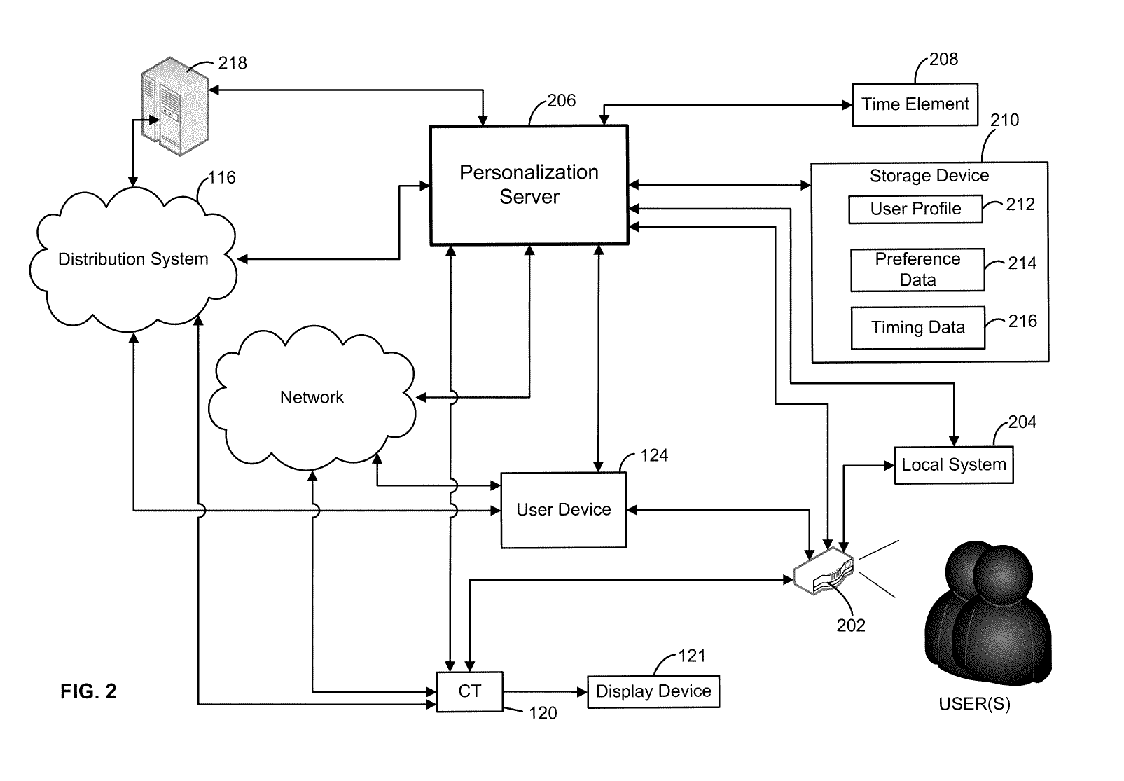

FIG. 2 illustrates various aspects of an exemplary network and system in which some of the disclosed methods and systems can operate. As an example, the distribution system 116 can communicate with the CT 120 (or other user device) via a linear transmission. Other network and/or content sources can transmit content to the CT 120. As a further example, the distribution system 116 can transmit signals to a video-on-demand (VOD) pump or network digital video recorder pump for processing and delivery to the CT 120. Other content distribution systems, content transmission systems, and/or networks can be used to transmit content signals to the CT 120.

In an aspect, the user device 124 can receive content from the distribution system 116, an Internet protocol network such as the Internet, and/or a communications network, such as a cellular network, for example. Other network and/or content sources can transmit content to the user device 124. As an example, the user device 124 can receive streaming data, audio and/or video for playback to the user. As a further example, the user device 124 can receive user experience (UX) elements such as widgets, applications, and content via a human-machine interface. In an aspect, user device 124 can be disposed inside or outside the user location 119.

In an aspect, a sensor 202 (or a combination of multiple sensors) can be configured to determine (e.g., capture, retrieve, sense, measure, detect, extract, or the like) information relating to one or more users. As an example, the sensor 202 can be configured to determine the presence of one or more users within a field of view of the sensor 202. As a further example, the sensor 202 can be configured to determine a user state, such as a behavior, biometrics, movement, physical and or chemical characteristics, location, reaction, and other characteristics relating to one or more users. Other characteristics, identifiers, and features can be detected and/or monitored by the sensor 202 such as gestures, sounds (e.g., voice, laughter), and environmental conditions (e.g., temperature, time of day, date, lighting, and the like).

In an aspect, the sensor 202 can comprise one or more of a camera, stereoscopic camera, wide-angle camera, visual sensor, thermal sensor, infrared sensor, biometric sensor, user tracking device, RF sensor, and/or any other device for determining a user state or condition. In an aspect, the sensor 202 can be configured for one or more of a facial recognition, gesture recognition, body heat analysis, behavioral analysis, eye tracking, head tracking, biometric analysis and/or other means of determining a user characteristic and or a change in a user characteristic. As an example, the sensor 202 can comprise software, hardware, algorithms, processor executable instructions, and the like to enable the sensor 202 to process any data capture or retrieved by the sensor 202. As a further example, the sensor 202 can transmit data captured or retrieved thereby to a device or system in communication with the sensor 202, such as a processor, server, the CT 120, and/or the user device 124.

In an aspect, the sensor 202 can be in communication with the CT 120 to transmit data relating to one or more users to the CT 120. However, the CT 120 can receive user-related data indirectly from the sensor 202, such as via a processor, a server, a control device, or the like. As an example, the sensor 202 can be disposed within a pre-determined proximity of the CT 120 and/or the display device 121 to determine information relating to one or more users within the pre-determined proximity of the CT 120 and/or display device 121. Accordingly, the CT 120 can be configured to personalize a user experience being rendered thereby in response to data received from the sensor 202 and based upon determined characteristics of the one or more users within the pre-determined proximity of the CT 120. However, the sensor 202 can be disposed in any location relative to the CT 120 and/or display device 121.

As an example, when a child is within the field, e.g., field of view of the sensor 202, data relating to the presence and/or user state of the child can be communicated to the CT 120. Accordingly, the content being rendered by the CT 120 and/or on the display device 121 can be automatically modified to age appropriate content based upon the data received from the sensor 202. As an example, certain content can be blocked, a channel can be changed, content can be restricted or settings relating to age appropriateness of a particular content can be modified for the appropriate age of the user Likewise, when the child exits the pre-determined range or proximity, the content or permissions for content presentation can be automatically modified based upon the user state of any remaining user or user(s) within the field of view of the sensor 202.

In an aspect, the sensor 202 can be in communication with the user device 124 to transmit data relating to one or more users to the user device 124. However, the user device 124 can receive user-related data indirectly from the sensor 202 such as via a processor, a server, a control device, or the like. As an example, the sensor 202 can be disposed on, in, or within a pre-determined proximity of the user device 124 to determine information relating to one or more users within the pre-determined proximity of the user device 124. Accordingly, the user device 124 can be configured to personalize a user experience being rendered thereby in response to data received from the sensor 202 and based upon determined characteristics of the one or more users within the pre-determined proximity of the user device 124. However, the sensor 202 can be disposed in any location relative to the user device 124.

As an example, the user device 124 can be configured to render an audio in a default language of English. However, when a Spanish speaking user is within the field of view of the sensor 202, data relating to the presence of the Spanish speaking user can be communicated to the user device 124. Accordingly, the audio being rendered by the user device 124 can be automatically modified to render in Spanish based upon the data received from the sensor 202. In addition, the Spanish audio can be delivered to the user by a unique manner as learned from the sensors 202, such that only that user is able to hear the Spanish audio. As an illustrative example, the Spanish audio can be RF modulated on a frequency that corresponds to an RF receiver the user is wearing. Likewise, when the Spanish speaking user exits the pre-determined range or proximity, the audio can be automatically modified to return to the default language.

In an aspect, the sensor can be in communication with a local system 204 such as a home security system, surveillance system, HVAC system, lighting system, and/or device or system disposed in a location (e.g., user location 119, or other location) where users can consume content. In an aspect, the sensor 202 can be in communication with the local system 204 to transmit data relating to one or more users to the local system 204. However, the local system 204 can receive user-related data indirectly from the sensor 202 such as via a processor, a server, a control device, or the like. As an example, the sensor 202 can be disposed on, in, or within a pre-determined proximity of the local system 204 to determine information relating to one or more users within the pre-determined proximity of the local system 204. Accordingly, the local system 204 can be configured to personalize a user experience being rendered thereby in response to data received from the sensor 202 and based upon determined characteristics of the one or more users within the pre-determined proximity of the local system 204. However, the sensor 202 can be disposed in any location relative to the user device 124. In an aspect, the local system 204 can be configured to transmit information relating to the parameters and settings of the local system 204. For example, the sensor 202 can receive information from an HVAC system relating to the current temperature of a given room. Other devices, processors, and the like can be in communication with the local system 204 to send and receive information therebetween.

As an example, the local system 204 can be configured to control the temperature and lighting of a particular room in response to the user experience preferences of a particular user that is detected in the room. As a further example, the local system 204 can comprise a plurality of cameras that can track one or more of the presence and movement of users throughout the user location 119, wherein such location information can be processed to define a localized user experience based upon any number of users in any given location.

In an aspect, a personalization server 206 can be in communication with one or more of the distribution system 116, the CT 120, the user device 124, the local system 204, the Internet, and/or a communication network to receive information relating to content being delivered to a particular user. As an example, the personalization server 206 can comprise software, virtual elements, computing devices, router devices, and the like to facilitate communication and processing of data. In an aspect, the personalization server 206 can be disposed remotely from the user location 119. However, the personalization server 206 can be disposed anywhere, including at the user location 119 to reduce network latency, for example.

In an aspect, the personalization server 206 can be configured to receive and process user data from the sensor 202 to determine a user presence and/or a user state based upon the data received from the sensor 202. As an example, the personalization server 206 can be configured for one or more of a facial recognition, gesture recognition, body heat analysis, behavioral analysis, eye tracking, head tracking, biometric analysis and/or other means of determining a user characteristic and or a change in a user characteristic. As an example, the sensor 202 can comprise software, hardware, algorithms, processor executable instructions, and the like to enable the sensor 202 to process any data captured or retrieved by the sensor 202.

In an aspect, a time element 208 can be in communication with at least the personalization server 206 to provide a timing reference thereto (e.g., timing references to timing/scheduling data in other content such as advertisements or other related content). As an example, the time element 208 can be a clock. As a further example, the time element 208 can transmit information to the personalization server 206 for associating a time stamp with a particular event or user data received by the personalization server 206. In an aspect, the personalization server 206 can cooperate with the time element 208 to associate a time stamp with events having an effect on content delivered to the CT 120 and/or the user device 124, such as, for example, a channel tune, a remote tune, remote control events, playpoint audits, playback events, program events including a program start time and/or end time and/or a commercial/intermission time, and/or playlist timing events, and the like. In an aspect, the personalization server 206 can cooperate with the time element 208 to associate a time stamp with user events, such as a registered or learned schedule of a particular user. For example, if a particular user listens to classical music during weekday evenings and watches sports during the weekends, the personalization server 206 can automatically control content presented to the user based upon a registered or learned schedule of the user's habits or preferences.

In an aspect, a storage media or storage device 210 can be in communication with the personalization server 206 to allow the personalization server 206 to store and/or retrieve data to/from the storage device 210. As an example, the storage device 210 can store information relating to user profiles 212, user preference data 214, timing data 216, device configurations, and the like. In an aspect, the storage device 210 can be a single storage device or may be multiple storage devices. As an example, the storage device 210 can be a solid state storage system, a magnetic storage system, an optical storage system or any other suitable storage system or device. Other storage devices can be used and any information can be stored and retrieved to/from the storage device 210 and/or other storage devices.

In an aspect, each of a plurality of user profiles 212 can be associated with a particular user. As an example, the user profiles 212 can comprise user identification information to distinguish one user profile 212 from another user profile 212. As a further example, the user profiles 212 can comprise user preference data 214 based upon one or more of user preferences, user permissions, user behavior, user characteristics, user reactions, and user-provided input.

In an aspect, the user preference data 214 can comprise information relating to the preferred user experience settings for a particular user. As an example, user preference data 214 can comprise preferred image, video, and audio content that can be provided directly by a user or can be learned based upon user behavior or interactions. As a further example, user preference data 214 can comprise preferred content settings (e.g., genre, ratings, parental blocks, subtitles, version of content such as director's cut, extended cut or alternate endings, time schedule, permission, and the like), environmental settings (e.g., temperature, lighting, tactile feedback, and the like), and presentation settings (e.g., volume, picture settings such a brightness and color, playback language, closed captioning, playback speed, picture-in-picture, split display, and the like), which can be provided by a user or learned from user habits and/or behavior. Other settings, preferences, and/or permission can be stored and/or processed as the user preference data 214.

In an aspect, timing data 216 can be associated with a particular user profile 212 for defining a temporal schedule. As an example, a user associated with one of the user profiles 212 may habitually watch action movies in low light conditions on the weekends. Accordingly, the timing data 216 can represent the learned content consuming pattern from the user and can apply such preferences to similar events in time and context, thereby personalizing the user experience without direct user interaction.

In an aspect, an advertisement system 218 can be in communication with one or more of the personalization server 206, the distribution system 116, the CT 120, the user device 124, the local system 204, the Internet, and/or a communication network to receive information relating to a user or users and to transmit personalized content (e.g., advertisements) to the particular user or users.

As described in greater detail below, a method for controlling a user experience can comprise identifying one or more users in a particular area and modifying a user experience based upon the particular users within the particular area.

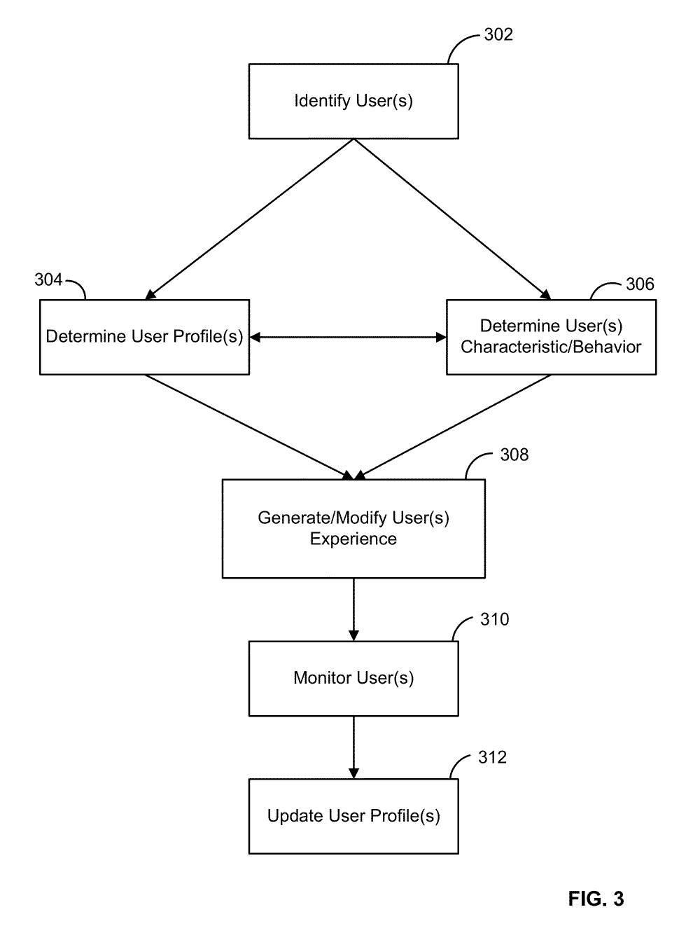

FIG. 3 illustrates an exemplary method for providing and controlling a user experience. The method illustrated in FIG. 3 will be discussed in reference to FIGS. 1-2, for illustrative purposes only. In step 302, one or more users are identified. In an aspect, the sensor 202 captures information (e.g., user data) relating to one or more users within the field of view of the sensor 202. As an example, the user data can be processed to determine an identity of one or more of the users within the field of view of the sensor 202 such as by facial recognition, gesture recognition, body heat analysis, behavioral analysis, eye tracking, head tracking, biometric analysis and/or other means of determining a user characteristic and or a change in a user characteristic. Other techniques can be used to identify a user or users including direct user query and/or user input. As a further example, the user data can be compared to stored data in order to determine an identity of one or more of the users within the field of view of the sensor 202.

In step 304, one or more user profiles are determined. In an aspect, determining a profile of a user can comprise retrieving one or more user profiles 212 from the storage device 210. As a non-limiting example, the user profile(s) 212 can comprise content preferences 214 and permissions associated with a particular user. Accordingly, in an aspect, the user data captured by sensor 202 can be processed to identify a particular user, and the user profile 212 associated with the identified user can be retrieved. As a further example, a new user profile 212 can be generated based upon one or more of a user input, a default profile template, and the user state data collected by the sensor 202. In an aspect, when a user enters the field of view of the sensor 202, the user can be queried to identify himself/herself. As an example, a holding place profile can be created for every user that enters the field of view of the sensor 202. However, the sensor 202 and related processing devices may not have a discrete identifier for the holding place profile until the user provides further information such as a name, token, character, or other discrete identifier. However, other identifiers can be used, such as biometric signatures, voice signatures, retinal signatures, and the like.

In step 306, a characteristic and/or behavior of one or more users can be determined such as by using the sensor 202. As an example, the user data can be processed to determine a user state, user characteristic and/or behavior of one or more of the users within the field of view of the sensor 202, such as by facial recognition, gesture recognition, body heat analysis, behavioral analysis, eye tracking, head tracking, biometric analysis and/or other means of determining a user characteristic and or a change in a user characteristic. In an aspect, the user characteristics, user state and/or user behavior determined can be used to generate and/or update one or more of the user profiles 212.

In step 308, a user experience can be generated and/or modified based upon one or more user profiles 212 and user states such as user characteristics and/or user behavior. Other data and/or metrics can be used to generate the user experience. In an aspect, the user experience can comprise a visual and/or audible content for user consumption. As an example, the user experience can comprise environmental characteristics such as lighting, temperature, tactile feedback, and/or other sensory feedbacks.

In an aspect, audio levels of an audio feedback can be modified based on a location of a user in a room. As an example, when the user moves from the family room, where the audio speakers are located, and into the kitchen, the audio level for the audio feedback can be increased. Likewise, when the user returns from the kitchen and enters the family room, the audio level of the audio feedback can be returned to the original level.

In an aspect, audio output can be directed to a specific location of a user within a given room. For example, when a user moves from one end of the room to the opposite end of the room, the audio output can be configured to follow the user across the room by varying the particular level of a plurality of speakers.

In an aspect, content can also be paused when a user leaves the room and un-paused when the user returns. As an example, the content control features can be dependent on content type. As a further example, when the content is a commercial, the content can continue to play and the volume would not be adjusted even when the user leaves the room.

In an aspect, content can be provided to a plurality of users located in the same area such as a room. As an example, various content can be rendered on a single display as a split screen (e.g., each quadrant of a display device rendering a different content). As a further example, audio corresponding to each of the quadrants of the display device can be transmitted to particular users based upon one ore more of each user's state, location, preferences, permissions, personal communication protocols (e.g., an RF frequency associated with an RF receiver the user is wearing), or the like. In an aspect, multiple screens in the same area or room can be individually controlled to provide personalized content and user experience to each of the users detected in the given area. As an example, a primary user can be established, thereby allowing only the primary user the permission to change the user experience, content and/or channel. As a further example, other users can request permission to have control of user experience. In an aspect, a pre-determined hierarchy of users and/or user profiles can be used to determine the manner in which the user experience is modified. For example, the user experience can be modified based upon one or more of a user profile and user state of a superior user that is within the field of view of the sensor 202. However, when the superior user exits the field of view, the user experience can be modified based upon one or more of the user profile and user state of the next user in the pre-determined hierarchy. In an aspect, a user experience can be controlled based upon a pre-defined rule set. As an example a rule set can define settings, whereby a primary user has control over the user experience for a particular portion of the day, but a default setting is used during another part of the day. Other rules and handling preferences can be used or defined by a user

In step 310, a characteristic and/or behavior of one or more users can be monitored such as by using the sensor 202, for example. As a further example, a change in characteristics (e.g., a reaction) of the user to a particular user experience and/or a change in behavior can be monitored, and data relating to the reaction/behavior of the user can be used to update the user profile associated with the particular user, as shown in step 312. Accordingly, an associated one of the user profiles 212 can be a dynamic, intelligent, and/or learning profile. In an aspect, a user behavior, user state, and/or user characteristic can be monitored to update the user experience directly. As an example, when the sensor 202 detects user characteristics that indicate the user is asleep, the audio level of the user experience can be reduced or muted so as not to disturb the user. Other users states, characteristics, behaviors, and reactions can be monitored to update one or more of the user experience and the user profiles 212.

As described in greater detail below, a device for rendering content can be controlled to automatically personalize a content parameter affecting the overall user experience. The content parameter can be personalized based on one or more users and/or user states identified.

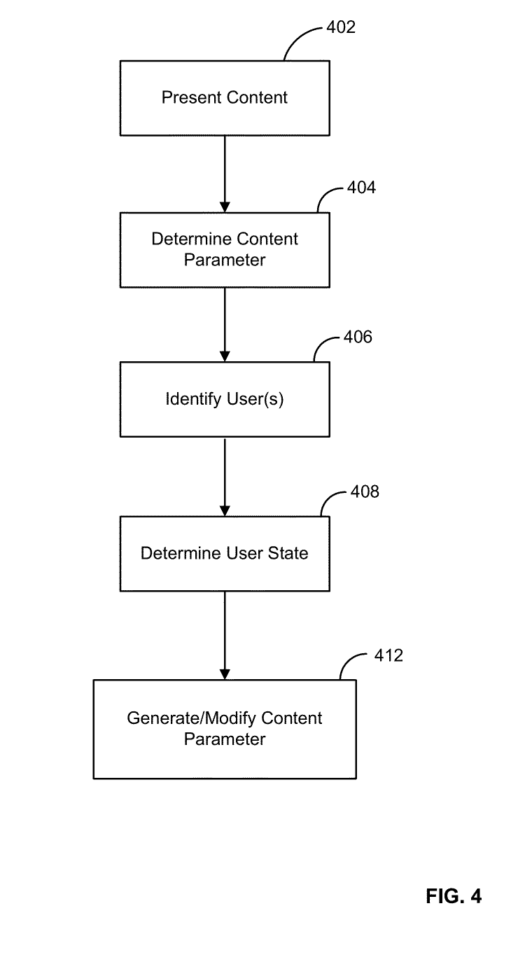

FIG. 4 illustrates an exemplary method for providing and controlling a user experience. The method illustrated in FIG. 4 will be discussed in reference to FIGS. 1-2, for illustrative purposes only. In step 402, a user experience can be provided for a particular user or users. As an example, the user experience can comprise an image, video, audio and/or tactile rendering.

In step 404, a content parameter such as a audio level, an output language, a closed captioning setting, a genre, a playback speed, a maturity rating, a content rating, a playback length, and the like can be determined. As an example, the content parameter can be determined by retrieving the information from metadata, header information, or embedded data in the content signal. As a further example, the content parameter can be determined based upon a setting of a particular content device such as the CT 120, the display device 121, and the user device 124.

In step 406, one or more users are identified. In an aspect, the sensor 202 captures information (e.g., user data) relating to one or more users within the field of view of the sensor 202. As an example, the user data can be processed to determine an identity of one or more of the users within the field of view of the sensor 202 such as by facial recognition, voice recognition, gesture recognition, body heat analysis, behavioral analysis, eye tracking, head tracking, biometric analysis and/or other means of determining a user characteristic and/or identifiable user signatures. As a further example, the user data can be compared to stored data (e.g., the user profiles 212) in order to determine an identity of one or more of the users within the field of view of the sensor 202.

In step 408, a user state can be determined for one or more of the users within the field of view of the sensor 202. In an aspect, the user state can be determined by retrieving a user profile 212 from the storage device 210, wherein the user profile comprises content preferences and permissions associated with the user. As an example, a user state can be determined in substantially real-time by processing the user data collected by the sensor 202 to determine a characteristic and/or behavior of one or users such as by facial recognition, voice recognition, gesture recognition, body heat analysis, behavioral analysis, eye tracking, head tracking, biometric analysis and/or other means of determining a user characteristic and or a change in a user characteristic.

In step 410, a user experience can be generated and/or modified based upon one or more user profiles 212 and user states, such as user characteristics and/or user behavior. Other data and/or metrics can be used to generate the user experience. As an example, the CT 120 and/or user device 124 can be controlled to unlock a particular content only if specific users are detected in the room (e.g., parents must be present to watch restricted content). As a further example, the CT 120 and/or user device 124 can be controlled to pause or stop the playback of content (including potentially switching to another content source) when certain users are detected in the room (e.g., channel change when child walks in).

As described in greater detail below, a system for rendering a user experience can be configured to automatically detect one or more users and personalize content based upon one or more users.

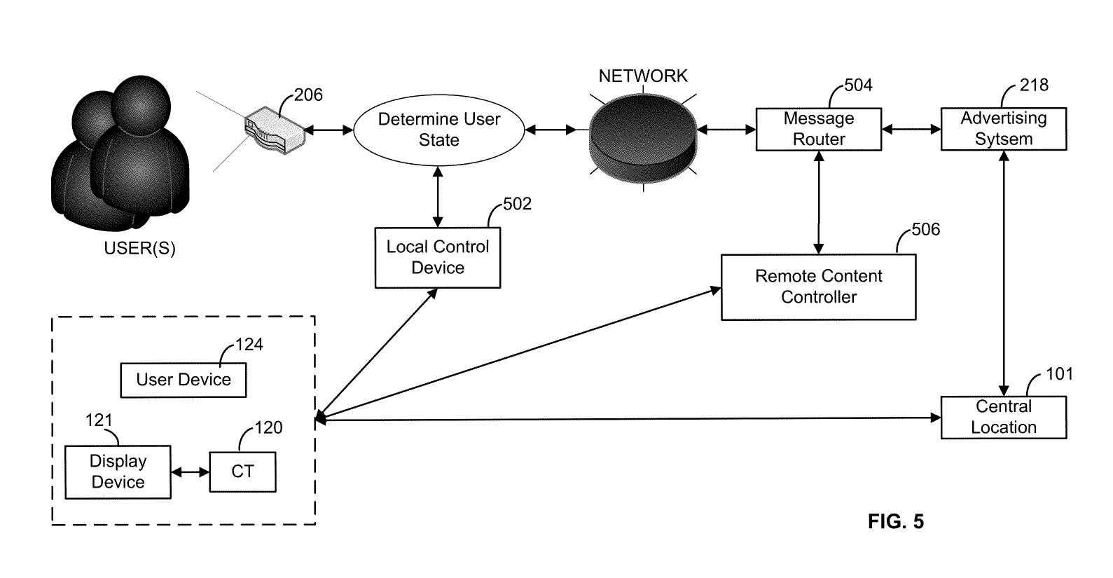

FIG. 5 illustrates various aspects of an exemplary network and system in which the present methods and systems can operate. In an aspect, the sensor 202 can be configured to determine (e.g., capture, sense, measure, detect, extract, or the like) information relating to one or more users. As an example, the sensor 202 can be configured to determine the presence of one or more users within a field of view of the sensor 202. As a further example, the sensor 202 can be configured to determine a user state, such as a behavior, biometrics, movement, physical and or chemical characteristics, location, reaction, and other characteristics relating to one or more users. In an aspect, the user state can comprise discrete classifications such as: “present”, where the user can consume the delivered content; “not present”, where the user is not in a position to consume the delivered content; “sleeping”, where the user's eyes are detected to be closed for a pre-determined threshold time period; and “not engaged”, where the user is “present”, however, detected gestures, characteristics and/or behavior indicate that the user is distracted from the delivered content. As an example, the user states can be classified in an manner and based upon any techniques or rules. As a further example, the user states can be dynamic or pre-defined states and can be modified for a particular user or user location 119.

In an aspect, the sensor 202 can be in communication with a local control device 502 for receiving the user state data from the sensor 202 to control the user experience provided by one or more of the CT 120 and the user device 124 in response to the user state. Local control devices can comprise, but are not limited to, infrared remote control devices, RF remote control devices, Bluetooth remote control devices, personal data assistants (PDAs), tablets, web pads, laptops, smart phones, etc. In an aspect, when the user leaves the room for a predetermined or user specific period of time, the display device 121 and/or user device 124 can be caused to enter an “off” state or “hibernate” state, conserving energy. As an example, when a user falls asleep the display device 121 and/or user device 124 can be placed into a sleep state. Conversely, when a sleeping user awakens, the display device 121 and/or user device 124 can be caused to exit a sleep state. As a further example, the user places the control device in its docking station, signaling an off state for all of the other devices in communication with the control device. Other device control and content control can be executed by the local content controller 502.

In an aspect, the sensor 202 can be in communication with a message router 504 (e.g., via a local network or a network such as the Internet) for distributing the user state data to downstream devices and/or systems for processing. As an example, the user state data can be transmitted to a remote content controller 506 to control the user experience provided by one or more of the CT 120 and the user device 124 in response to the user state. In an aspect, when a particular user enters a room a lookup can be conducted against a recommendation engine to automatically change the channel based on user preferences. As an example, an adult male may be tuned to NBC sports, while a child would be turned to Sprout when they enter the room. Other device control and content control can be executed by the remote content controller 506.

As a further example, the user state data can be transmitted to a content management system or content source, such as the advertising system 218, in order to select a particular personalized content (e.g., advertisement) based upon the user state information. In an aspect, information can be retrieved from an associated user profile and can be used in conjunction with the user state data to select the personalized content for deliver to the user. As an example, the personalized content can be routed to the one or more of the CT 120 and the user device 124 via the central location 101 or other server, router, network, distribution system, or the like.

As described in greater detail below, a method for controlling a user experience can comprise identifying one or more users and/or user states and communicating the identified user data to controllers for modifying a user experience based upon the particular user data.

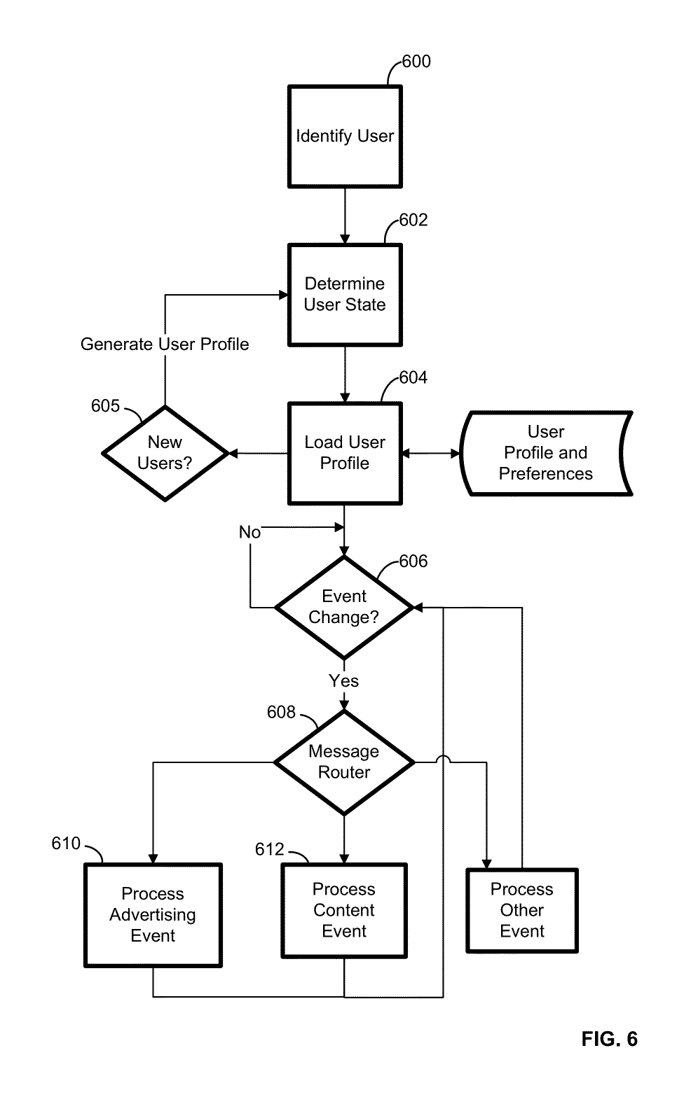

FIG. 6 illustrates an exemplary method for providing and controlling a user experience. The method illustrated in FIG. 6 will be discussed in reference to FIGS. 1-5, for illustrative purposes only. In step 600, one or more users are identified. In an aspect, the sensor 202 captures information (e.g., user data) relating to one or more users within the field of view of the sensor 202. As an example, the user data can be processed to determine an identity of one or more of the users within the field of view of the sensor 202, such as by facial recognition, voice recognition, gesture recognition, body heat analysis, behavioral analysis, eye tracking, head tracking, biometric analysis and/or other means of determining a user characteristic and/or identifiable user signatures. As a further example, the user data can be compared to stored data (e.g., the user profiles 212) in order to determine an identity of one or more of the users within the field of view of the sensor 202.

In step 602, a user state can be determined for one or more of the users within the field of view of the sensor 202. In an aspect, a user state can be determined in substantially real-time by processing the user data collected by the sensor 202 to determine a characteristic and/or behavior of one or users, such as by facial recognition, voice recognition, gesture recognition, body heat analysis, behavioral analysis, eye tracking, head tracking, biometric analysis and/or other means of determining a user characteristic and or a change in a user characteristic. As an example, the user state can be at least partially determined by retrieving a user profile 212 from the storage device 210, wherein the user profile can comprise content preferences and/or permissions associated with the user, as shown in step 604.

In step 605, a new user can be identified, for example, as a user not having a user profile 212 or previously stored user states and/or preferences. In an aspect, a template profile or holding place profile can be associated with a new user that does not have a signature or identify associated therewith. In this way, the template profile can provide a personalized user experience to the new user without having to identify the user by a unique identifier. As a further example, a new user profile 212 can be generated based upon one or more of a user input, a default profile template, and the user state data collected by the sensor 202. In an aspect, when a user enters the field of view of the sensor 202, the user can be queried to identify himself/herself. As an example, the user profile 212 of a registered user or identified user can be updated based upon the user state determined in step 602.

In step 606, user data comprising one or more of the user states and the user profiles 212 are processed to determine if an event has occurred. As an example, a pre-defined set of rules can be established to compare against the user data to determine if a change in user experience or content is required. As a further example, the set of rules can be based upon a user action and/or user movement, such as entering or leaving a viewing area, an attention of viewers in the room, external events like phones ringing, door bells, or devices that might make noise requiring the volume to be increased (e.g., cooking in a kitchen). In an aspect, the rules can be based upon specific individual user movements such as arm/hand gestures, eye movements, facial expressions, sounds, voice level and the like. Specific activities can be relied upon to establish presence, circumstance, controllable changes and related experience defining inputs that uniquely define each comparable event.

In step 608, the user data can be transmitted to the message router for distribution to devices or system for downstream processing. As an example, a pre-defined algorithm or a learning/AI system can be configured to correlate the inputs to determine a response or action. In an aspect, certain events may require a message transmission to the central location 101 to play a different advertisement or content. Certain events may only require an in-home action such as control of lighting, sound, security systems, or other connected components. However, a single action/event change can result in more than one action (e.g., play an advertisement and turn on the lights). In an aspect, data, such as images, video, sound and transactional data relating to activity of each individual and detected events, can be transmitted and stored in order to build related profile and matching criteria.

In step 610, the user data can be transmitted to a content management system or content source, such as the advertising system 218, in order to select a particular personalized content (e.g., advertisement) based upon the user state information. As an example, the user data can be used to provide a particular content such as an advertisement to the user.

In step 612, the user data can be transmitted to the local control device 502 and/or the remote content controller 506 to control the user experience provided by one or more of the CT 120 and the user device 124 in response to the user state. As an example, one or more of the local control device 502 and/or the remote content controller 506 can be configured to provide control information to one or more of the CT 120, the user device 124, the local system 204, and/or other systems relating to the user or user experience based on the user data. Other events can be detected such as temporal events, planned events, environmental events, and the like in order to control a user experience and/or content.

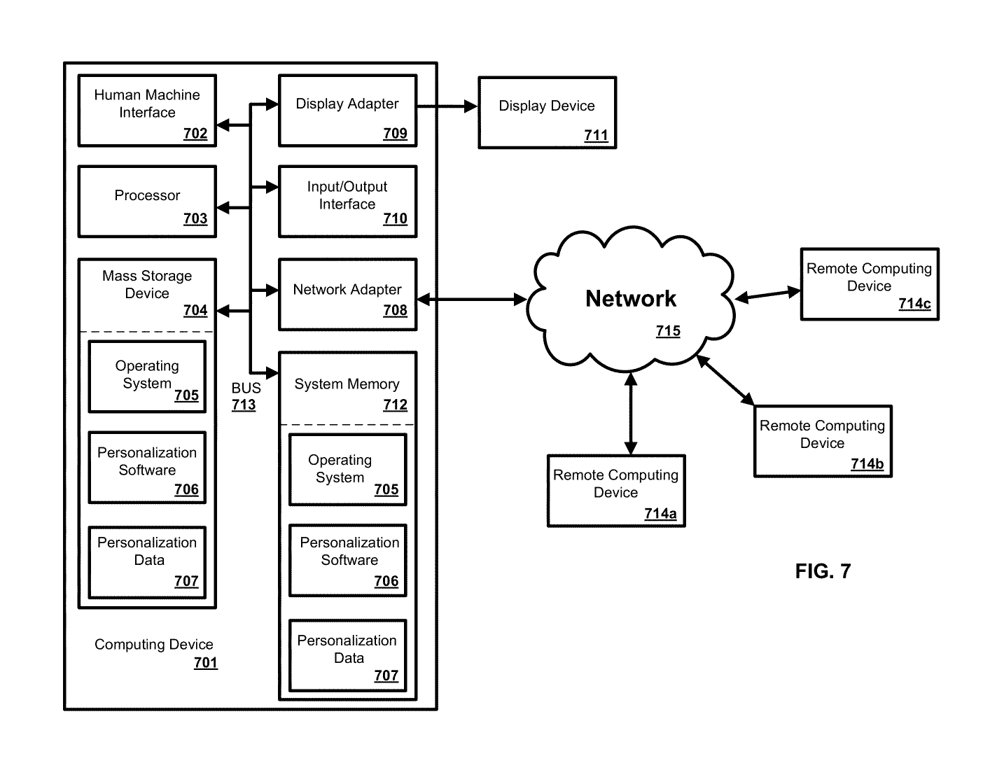

In an exemplary aspect, the methods and systems can be implemented on a computing device such as computing device 701 as illustrated in FIG. 7 and described below. By way of example, server 110 of FIG. 1 can be a computer as illustrated in FIG. 7. Similarly, the methods and systems disclosed can utilize one or more computers to perform one or more functions in one or more locations. FIG. 7 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 701. The components of the computing device 701 can comprise, but are not limited to, one or more processors or processing units 703, a system memory 712, and a system bus 713 that couples various system components including the processor 703 to the system memory 712. In the case of multiple processing units 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, personalization software 706, user data and/or personalization data 707, a network adapter 708, system memory 712, an Input/Output Interface 710, a display adapter 709, a display device 711, and a human machine interface 702, can be contained within one or more remote computing devices 714a,b,c at physically separate locations, connected through buses of this form, in effect implementing a fully distributed system.

The computing device 701 typically comprises a variety of computer readable media. Exemplary readable media can be any available media that is accessible by the computing device 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data such as personalization data 707 and/or program modules such as operating system 705 and personalization software 706 that are immediately accessible to and/or are presently operated on by the processing unit 703.

In another aspect, the computing device 701 can also comprise other removable/non-removable, volatile/non-volatile computer storage media. By way of example, FIG. 7 illustrates a mass storage device 704 which can provide non-volatile storage of computer code, computer readable instructions, data structures, program modules, and other data for the computing device 701. For example and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and personalization software 706. Each of the operating system 705 and personalization software 706 (or some combination thereof) can comprise elements of the programming and the personalization software 706. Personalization data 707 can also be stored on the mass storage device 704. Personalization data 707 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 701 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 703 via a human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another aspect, a display device 711 can also be connected to the system bus 713 via an interface, such as a display adapter 709. It is contemplated that the computing device 701 can have more than one display adapter 709 and the computing device 701 can have more than one display device 711. For example, a display device can be a monitor, an LCD (Liquid Crystal Display), or a projector. In addition to the display device 711, other output peripheral devices can comprise components such as speakers (not shown) and a printer (not shown) which can be connected to the computing device 701 via Input/Output Interface 710. Any step and/or result of the methods can be output in any form to an output device. Such output can be any form of visual representation, including, but not limited to, textual, graphical, animation, audio, tactile, and the like. The display 711 and computing device 701 can be part of one device, or separate devices.

The computing device 701 can operate in a networked environment using logical connections to one or more remote computing devices 714a,b,c. By way of example, a remote computing device can be a personal computer, portable computer, smart phone, a server, a router, a network computer, a peer device or other common network node, and so on. Logical connections between the computing device 701 and a remote computing device 714a,b,c can be made via a network 715, such as a local area network (LAN) and/or a general wide area network (WAN). Such network connections can be through a network adapter 708. A network adapter 708 can be implemented in both wired and wireless environments. Such networking environments are conventional and commonplace in dwellings, offices, enterprise-wide computer networks, intranets, and the Internet.

For purposes of illustration, application programs and other executable program components such as the operating system 705 are illustrated herein as discrete blocks, although it is recognized that such programs and components reside at various times in different storage components of the computing device 701, and are executed by the data processor(s) of the computer. An implementation of personalization software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for providing a user experience comprising:
identifying a user;
obtaining a profile of the user;
determining a parameter of a user experience; and
automatically modifying the parameter of the user experience based upon the profile of the user.

2. The method of claim 1, wherein the user is automatically identified based upon user data captured by a sensor.

3. The method of claim 1, wherein determining a profile of the user comprises retrieving the profile from a storage media.

4. The method of claim 1, wherein determining a profile of the user comprises generating the profile based upon one or more user states.

5. The method of claim 1, wherein the profile of the user comprises one or more content preferences associated with the user.

6. The method of claim 1, wherein the parameter is one or more of content, an audio parameter, a video parameter, an image parameter, a playback speed parameter, and an environmental parameter.

7. A method for providing a user experience comprising:
identifying a user;
determining a profile of the user;
automatically modifying a parameter of the user experience based upon the profile of the user;
monitoring a state of the user; and
modifying one or more of the profile of the user and the user experience to reflect the state of the user.

8. The method of claim 7, wherein monitoring a state of the user comprises one or more of: monitoring a behavior of the user, monitoring an interaction between the user and an a local device, monitoring a characteristic of the user, monitoring a location of the user, monitoring a movement of the user, and monitoring a reaction of the user to the user experience.

9. The method of claim 7, further comprising updating the parameter of the content based upon the monitored state of the user.

10. The method of claim 7, wherein the state of the user comprises presence of the user and the user experience is modified based upon the presence of the user.

11. A method for providing a user experience comprising:
identifying a user;
determining a state of the user; and
automatically modifying a parameter of the user experience based upon the state of the user.

12. The method of claim 11, wherein determining a state of the user comprises one or more of, monitoring a behavior of the user, monitoring an interaction between the user and an a local device, monitoring a characteristic of the user, monitoring a location of the user, monitoring a movement of the user, and monitoring a reaction of the user to the user experience.

13. The method of claim 11, wherein the user is automatically identified based upon user data captured by a sensor.

14. The method of claim 11, wherein identifying the user comprises identifying a plurality of individuals.

15. The method of claim 11, wherein the state of the user comprises presence of the user and the user experience is modified based upon the presence of the user to pause a content when the user is not present.

16. The method of claim 11, wherein the state of the user comprises presence of the user and the user experience is modified based upon the presence of the user to present an advertisement based on the presence of the user.

17. The method of claim 11, wherein the state of the user comprises a preferred language of the user and the user experience is modified to present audio in the preferred language of the user.

18. The method of claim 11, wherein the state of the user comprises a permission setting associated with the user and the user experience is modified to render user-appropriate content.

19. A method for personalization of content comprising:
identifying a plurality of users;
determining a plurality of profiles, wherein each profile is associated with a respective user of the plurality of users; and
rendering a personalized user experience to each of the users based upon the plurality of profiles.

20. The method of claim 19, wherein the personalized content is rendered via a single device.

21. The method of claim 19, wherein one of the plurality of profiles is identified as a control profile, whereby rendering a personalized user experience to each of the users is based upon the control profile.

22. The method of claim 19, further comprising:
determining a parameter of content presented to the plurality of users; and
automatically modifying the parameter of the content based upon one or more the profiles of the users.

23. A method for personalization of content comprising:
identifying a user;
determining a profile of the user;
processing a plurality of available content to determine a preferred content based upon the profile of the user; and
rendering the preferred content.

24. The method of claim 23, wherein the user is automatically identified based on data captured by a sensor.

25. The method of claim 23, wherein determining a profile of the user comprises retrieving the profile from a storage media.

26. The method of claim 23, wherein determining a profile of the user comprises generating the profile based upon a state of the user and a direct user feedback.

27. The method of claim 23, wherein the profile of the user comprises one or more of content preferences and permissions associated with the user.

28. The method of claim 23, further comprising monitoring a state of the user.

29. The method of claim 28, wherein determining a profile of the user comprises modifying the profile based upon the state of the user.

30. The method of claim 28, wherein monitoring a state of the user comprises monitoring a reaction of the user to the preferred content.
